(19) United States
(12) Patent Application Publication
(10) Pub. No.: US 2012/0108086 A1
(43) Pub. Date: May 3, 2012

(54) BICYCLE METER

(75) Inventor: Kwong Yuen Wai, Aberdeen (HK)

(73) Assignee: National Electronics & Watch Co. Ltd., Aberdeen (HK)

(21) Appl. No.: 12/938,115

(22) Filed: Nov. 2, 2010

(51) Int. Cl. H01R 13/44

(52) U.S. Cl. 439/131

(57) ABSTRACT

A bicycle meter including a rechargeable battery, and a retractable USB plug movable between a retracted position and an extended position. In addition, the USB plug is connectable with a USB port to transfer data between the bicycle meter and a computer and to recharge the rechargeable battery, when the USB plug is in the extended position.

### TECHNICAL FIELD

The invention concerns a bicycle meter.

### BACKGROUND OF THE INVENTION

A conventional bicycle meter assembly is fixed to a handle bar. The meter assembly comprises an integrated circuit board therein, an LCD screen and control buttons. When the corresponding buttons are pressed the LCD screen will display data, such as the speed of the bicycle and the time.

Small batteries are required to power the meter, and need to be regularly replaced when they are depleted of energy.

### SUMMARY OF THE INVENTION

In a first preferred aspect, there is provided a bicycle meter including a rechargeable battery, and a retractable USB plug movable between a retracted position and an extended position. In addition, the USB plug is connectable with a USB port to transfer data between the bicycle meter and a computer and to recharge the rechargeable battery, when the USB plug is in the extended position.

The USB plug may be slidable between the retracted position and the extended position.

The USB plug may be provided in a raised central portion on a rear surface of the meter.

The raised central portion may have a pair of side recesses to engage with the a portion of the lateral edges of the USB plug such that a sliding mating relationship is provided.

### BRIEF DESCRIPTION OF THE DRAWINGS

An example of the invention will now be described with reference to the accompanying drawings, in which:

FIG. 1 is a perspective view from below of a bicycle meter in accordance with an embodiment of the present invention with a retractable USB plug in a retracted position;

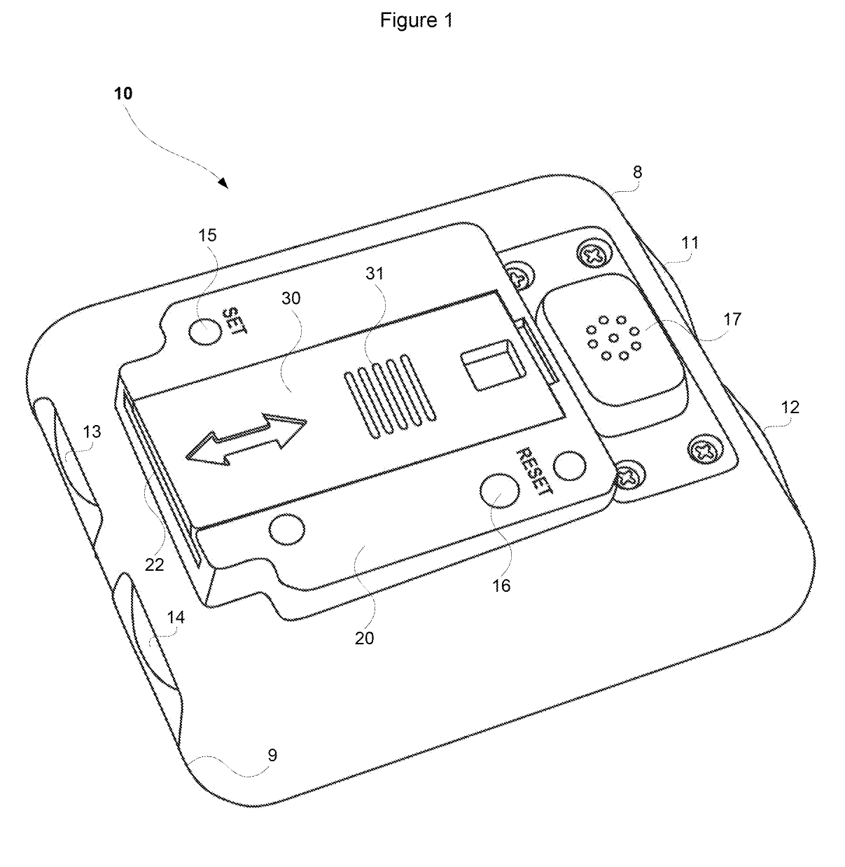

FIG. 2 is a perspective view from below of the bicycle meter of FIG. 1 with the USB plug in an extended position; and

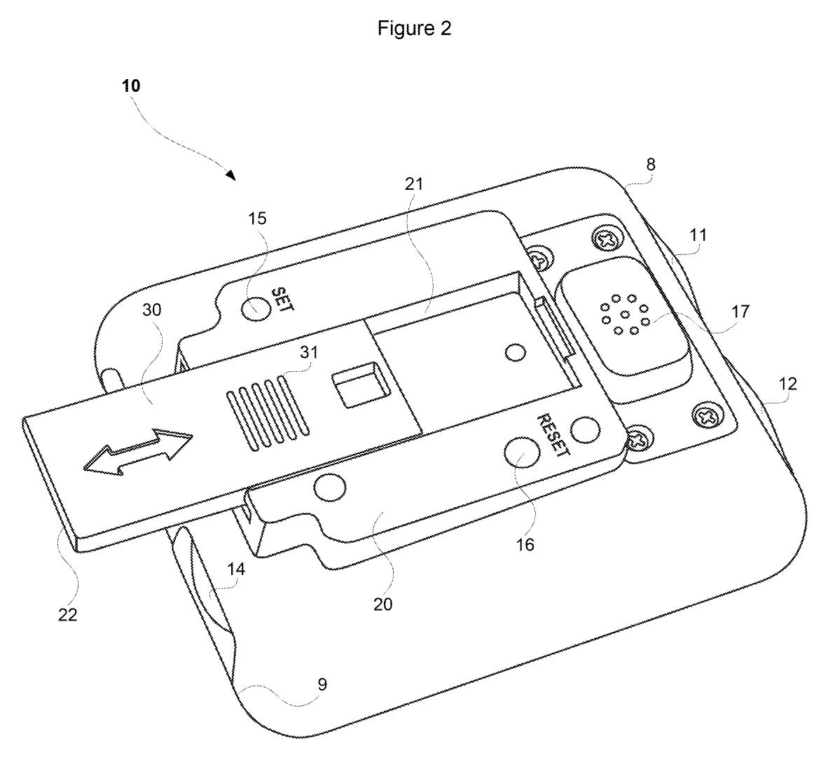

FIG. 3 is a perspective view from above of the front side of the bicycle meter of FIG. 1.

### DETAILED DESCRIPTION OF THE DRAWINGS

Referring to the drawings, a bicycle meter 10 is provided. A front surface of the bicycle meter 10 has a LCD screen to display data such as speed, time, etc. Two control buttons 11, 12 are located along the top edge 8 of the meter 10 and another two control buttons 13, 14 are located along the bottom edge 9 of the meter 10. Pressing certain control buttons 11, 12, 13, 14 starts the meter 10, stops the meter 10 or changes the display data on the LCD screen.

On the rear surface of the meter 10, a speaker 17 is located at an upper portion. When the buttons 11, 12, 13, 14 are pressed or when a certain amount of time has elapsed, an audible sound will be generated. Also, a set button 15 and reset button 16 are provided in the event the meter 10 needs to set the clock or to reset all functions to the default mode.

At a central raised portion 20 on the rear surface of the meter 10 is a retractable USB plug 30. When in an extended position, the USB plug 30 connects a USB port to receive power to re-charge the batteries of the meter 10. Also, data may be transferred between the meter 10 and a computer to monitor and record the performance of the user.

The USB plug 30 is in a sliding mating relationship with a pair of side recesses 21 defined in the central raised portion 20. The top surface of the USB plug 30 is flush with the top surface of the central raised portion 20. A ribbed area 31 on the top surface of the USB plug 30 assists the user by providing greater friction when using their finger to slide the USB plug 30 back and forth. An upper end of the USB plug 30 is wider relative to the rest of the USB plug 30 so that this wider upper end sits within the side recesses 21 and enables the USB plug 30 to slide back and forth relative to the central raised portion 30. The USB plug 30 in the extended position, extends beyond a body portion of the meter 10 so that the electrical pins 22 of the USB plug 30 can easily be inserted into a USB port.

There are four metal pins at a lower end of the central raised portion 20 that make electrical contact with the connectors on the bottom surface of the USB plug 30. This enables both data and power to be transferred between a computer and the memory and battery of the meter 10 at the same time. Enabling data transfer and power charging at the same time saves the person some time.

The meter 10 is 45 mm wide and 52 mm long. In the extended position, the USB plug 30 extends about 11 mm beyond the body portion of the meter. The width of the USB plug 30 is 12 mm. The width of the central raised portion 20 is 27 mm and the length is 31 mm. The thickness of the meter 10 from the front surface to the top surface of the central raised portion 20 is 15 mm.

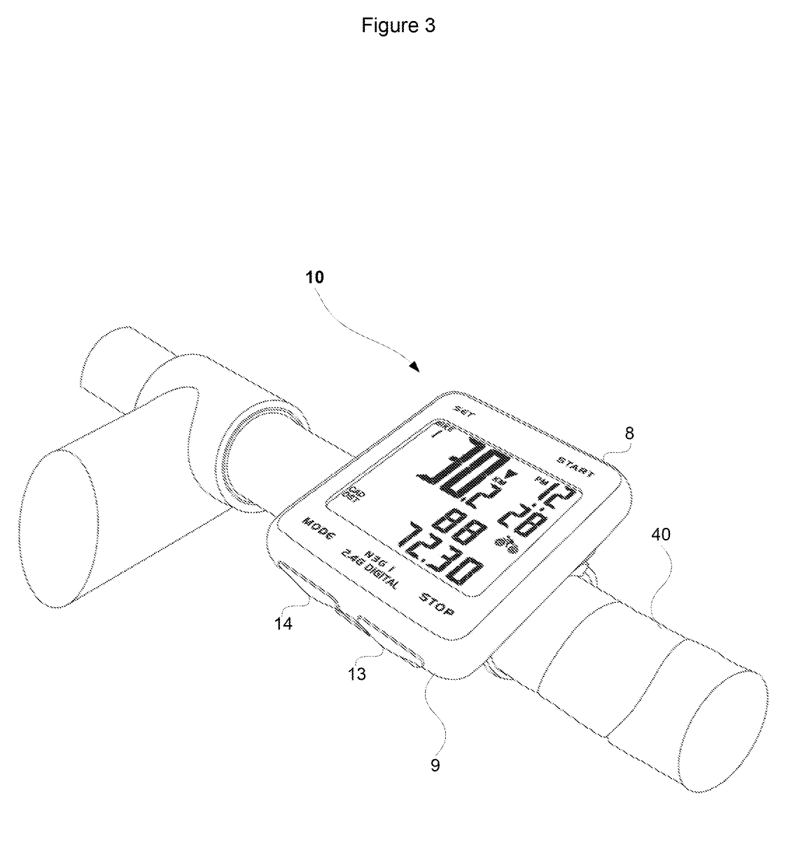

Turning to FIG. 3, in use, the meter 10 is operatively attached to the handle bar 40 of a bicycle. The front side of the meter 10 is substantially a touch screen which means the user may select the mode, set, start and stop functions easily without much force required. Also, the display area on the front side of the meter 10 is large and comprises the majority of the surface area of the front side to provide useful and detailed information in a large enough text without requiring the user to move their head closer to the meter 10.

Although a USB plug has been described, it is possible that other communication standards may be used, for example, an IEEE 1394 interface.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

What is claimed:

1. A bicycle meter, comprising:
a rechargeable battery; and
a retractable USB plug movable between a retracted position and an extended position;
wherein the USB plug is connectable with a USB port to transfer data between the bicycle meter and a computer and to recharge the rechargeable battery, when the USB plug is in the extended position.

2. The meter according to claim 1, wherein the USB plug is slidable between the retracted position and the extended position.

3. The meter according to claim 2, wherein the USB plug is provided in a raised central portion on a rear surface of the meter.

4. The meter according to claim 1, wherein the raised central portion has a pair of side recesses to engage with the a portion of the lateral edges of the USB plug such that a sliding mating relationship is provided.
